(19) United States
(12) Patent Application Publication
(10) Pub. No.: US 2010/0155378 A1
(43) Pub. Date: Jun. 24, 2010

(54) Battery Manufacturing

(76) Inventors: Hans-Herbert Fuchs, Hofheim (DE); Rudolph Majthan, Eschborn (DE); Stefan Eich, Oberursel (DE); Mark C. Brown, Brookfield, CT (US)

Correspondence Address: FISH & RICHARDSON P.C., P.O. BOX 1022, MINNEAPOLIS, MN, 55440-1022, US

(21) Appl. No.: 12/338,032

(22) Filed: Dec. 18, 2008

(51) Int. Cl. B23K 26/00; H01M 6/00

(52) U.S. Cl. 219/121.64; 29/623.1

(57) ABSTRACT

A method of manufacturing a battery is provided. A cathode assembly is provided, including a cathode and a cathode tab. The cathode tab is welded to a positive terminal of the battery. The areas to be welded are cleaned prior to welding to remove an oxide layer.

### TECHNICAL FIELD

This invention relates to battery manufacturing, and more particularly to methods of welding a cathode to a portion of the battery with which it is in electrical communication in the finished battery.

### BACKGROUND

A battery generally includes a cathode, an anode, and an electrolyte, disposed in a housing, often referred to as a “can” or “casing.”

The cathode may in some cases be prepared in the form of a slurry which contains solids which include the cathode active material, conductive carbon particles, and binder. Solvents are added to dissolve the binder and provide good dispersion and mixing of the solid components in the slurry. The cathode slurry is coated onto one or both sides of a thin conductive substrate, and then dried to evaporate the solvents and leave a dry cathode coating on one or both sides of the substrate, forming a cathode composite sheet.

A cell electrode assembly is formed with a sheet of anode material, for example lithium in the case of a lithium ion cell, the cathode composite sheet containing the cathode active material, and a separator between the anode and cathode. The electrode assembly may be spirally wound and inserted into the cell casing, for example, as shown in U.S. Pat. No. 4,707,421. A portion of the anode sheet (e.g., an anode tab) is typically electrically connected to the cell casing which forms the cell's negative terminal. The cell is closed with an end cap which is insulated from the casing. A cathode tab extending from the cathode composite sheet can be electrically connected to the end cap which forms the cell's positive terminal, for example by welding. The casing is typically crimped over the peripheral edge of the end cap to seal the casing's open end.

In some cases, it is difficult to weld the cathode tab to the end cap. For example, if the cathode tab and the end cap are made of aluminum, an oxide layer tends to form on the aluminum which can cause welding problems and/or damage to and break-off of the cathode tab. This is at least in part due to the welding point of aluminum oxide being much greater than that of aluminum (2053° C. vs. 658° C.).

### SUMMARY

In one aspect, the invention features a method of manufacturing a battery, the method comprising: (a) providing a battery housing including a housing body and a portion defining a positive battery terminal; (b) providing a cathode assembly, comprising a cathode and a cathode tab configured to allow the cathode to be connected to the positive battery terminal; (c) cleaning a region of the cathode tab and/or a region of the positive battery terminal to remove an oxide layer from at least one of these regions; and (d) welding together the region of the cathode tab and the region of the positive battery terminal within 5 minutes of the cleaning step.

In some implementations, both cleaning and welding are performed using a laser beam, with a relatively low power density beam being used for cleaning and a relatively higher power density beam being used for welding.

The invention also features batteries manufactured using the methods disclosed herein.

The details of one or more embodiments of the invention are set forth in the accompanying drawings and the description below. Other features and advantages of the invention will be apparent from the description and drawings, and from the claims.

### DESCRIPTION OF DRAWINGS

FIG. 1 is a cross-sectional view of the upper portion of a cylindrical battery.

FIG. 2 is a flow diagram illustrating a process according to one implementation.

### DETAILED DESCRIPTION

In the preferred methods disclosed herein, an oxide film is substantially completely removed from the welding area between a cathode tab and a portion of the battery to which the cathode tab is to be welded, e.g., the contact cup of the end cap assembly, to allow a reliable, high strength weld to be formed between the two parts. The oxide film is preferably removed immediately before welding, so that the welding area is substantially oxide-free during welding. The oxide film may be removed from the cathode tab, the region to which it is to be welded, or both.

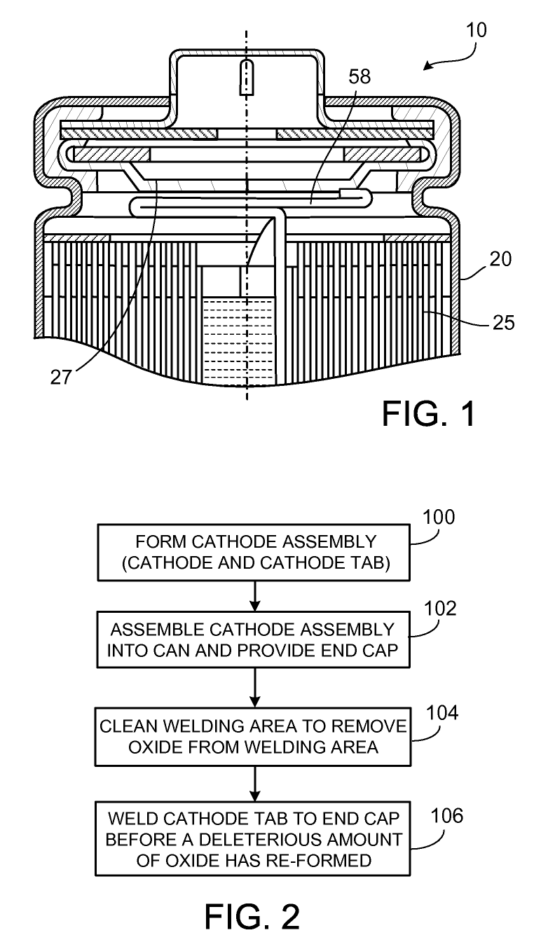

An example of a cell 10 is shown in FIG. 1. Cell 10 includes a housing or “can” 20, an anode sheet, which may, for example, comprise lithium metal or other anode active material, a separator, and a cathode sheet. The cathode sheet includes a cathode active material. If the anode comprises lithium metal, the cathode active material can be, for example, iron disulfide (FeS₂). In some implementations, the anode, cathode, and separator define a spiral wound electrode assembly 25, as shown, which can be prepared by spirally winding a flat electrode composite. The cell also includes an electrolyte.

The cell may be cylindrical, or may be in the form of a spirally wound flat cell or prismatic cell, for example a rectangular cell having the overall shape of a cuboid. For a spirally wound cell, a preferred shape of the housing 20 is cylindrical, as shown in FIG. 1.

In some implementations, the cathode active is coated on a cathode substrate, e.g., aluminum foil or stainless steel, to form a cathode composite sheet. In such implementations, the cathode substrate can function as a current collector. A cathode tab 58, which can be formed, for example, of Aluminum 1145, is then attached, e.g., ultrasonically welded, to the cathode substrate. The cathode tab may have any desired dimensions. It may, for example, be about 50 to 60 mm long, 4 to 6 mm wide, and 0.05 to 0.15 mm thick, e.g., 0.09 to 0.11 mm thick. The thickness is selected to facilitate processing as well as enhance the current carrying capability of the product. Aluminum is preferred for its positive polarity and because aluminum is electrochemically stable at the potential encountered in use. In some implementations, the cathode tab is located at the lead edge of the cathode. However, the tab can be located anywhere along the cathode length. It can be desirable to have the cathode tab and anode tab at opposite ends of the electrode assembly is this generally provides uniform current distribution and hence uniform discharge along the entire electrode length.

During cell assembly, the cathode tab 58 is connected to the positive terminal of the battery. The positive terminal consists of an assembly that includes multiple parts. One of the parts is a contact cup 27. This part can be made, for example, of Aluminum 5052 H34, and generally includes a safety vent. The aluminum cathode tab is welded to this contact cup, e.g., by laser welding. The typical diameter of the fusion nugget (welded bond area) is about 0.4 to 0.5 mm (not including the heat-affected zone (HAZ)). Typical depth of weld penetration is about 40 to 60% of the thicker material of the two.

The cathode tab 58 and the contact cup 27 to which it is welded are generally both relatively thin, making them particularly susceptible to welding damage if an oxide layer is present during welding. For example, in some implementations, the cathode tab is less than 0.2 mm thick, e.g., about 0.1 mm thick, while the contact cup to which it is being welded is less than 0.5 mm thick, e.g., about 0.3 mm thick.

FIG. 2 illustrates a process for welding the cathode tab 58 to the contact cup 27 (or to any other suitable area of the battery). First, in step 100, the cathode assembly is formed, in any desired manner, including attachment of the cathode tab 58 to the cathode. Next, in step 102, the cathode assembly is assembled into a can or other suitable housing, and an end cap assembly is provided which will seal the housing in the finished battery and form the positive terminal of the battery. These steps can be completed at any time prior to welding of the cathode tab to the end cap assembly.

The next step—cleaning of the welding area (step 104)—should be performed as close in time to the welding step (step 106) as possible. In preferred implementations, step 106 is performed within less than 10 minutes of the completion of step 104, more preferably less than 5 minutes, for example less than one minute. In some implementations, welding is performed within 30 seconds, 20 seconds, 15 seconds, or even 5 seconds or less, from the completion of the cleaning step. By minimizing the time between cleaning and welding, re-formation of oxide on the surfaces to be welded is also minimized.

The cleaning step may include a mechanical process, a chemical process, and/or a physical process. Examples of mechanical processes include milling, turning, scratching, scraping, brushing, buffing, sanding and the like. Examples of chemical processes include etching, e.g., chemical etching and electrolytic etching. One suitable physical process is laser removal.

In the case of laser removal, a laser beam configured for cleaning may be applied to the parts to be welded immediately prior to welding. The laser beam used for cleaning may be, for example, an Nd-YAG laser. The Nd-YAG beam is particularly effective when the substrates to be welded are aluminum, as the wavelength of an Nd-YAG laser is well matched to the absorption curve of aluminum.

A suitable system utilizing an Nd-YAG laser is the laser system commercially available from Trumpf under the tradename VectorMark Compact 1. The laser head may have, for example, a 163 mm focus lens and may run at a power of about 5.5 W and a frequency of about 16 KHz.

The area that is cleaned is at least as large as the area to be welded, and preferably has a larger diameter than the area that is to be welded. In some implementations, the diameter of the cleaned area is at least 50%, for example at least about 80%, at least 100%, or at least about 120%, larger than the diameter of the weld. For example, to weld an area having a diameter of 1.2 mm it is preferred to clean an area of at least 2 mm or in some cases at least 4 mm.

The cleaning time may be, for example, from about 0.1 to about 1.0 second, e.g., about 0.3 to about 0.4 second.

Advantageously, laser removal allows the depth of cleaning to be closely controlled to a predetermined specification. In some cases, the depth of cleaning is controlled to a tolerance of less than about ±20%. In some implementations, the depth of cleaning is from about 5 to about 15 μm, e.g., from about 8 to about 12 μm.

Preferably, substantially the entire weld area is cleaned. If desired, the entire area of the cathode tab and/or the entire area of the contact cup.

Finally, in step 106, the cathode tab and the contact cup (or other area of the positive battery terminal) are welded together. In some implementations, welding is performed using a laser beam. The laser beam used for welding may also be an Nd-YAG laser, but is one having a higher power density than the laser used for cleaning.

A number of embodiments of the invention have been described. Nevertheless, it will be understood that various modifications may be made without departing from the spirit and scope of the invention.

For example, while a Nd-YAG system is discussed in detail above, other types of lasers and other types of chemical and mechanical processes may be used to remove the oxide layer. Any desired type of welding process may be used that is capable of attaching the cathode tab to the end cap assembly, for example laser welding, arc welding, gas welding, ultrasonic welding, friction welding or other welding processes. The cell may be of any size, for example, AAAA (40.2×8.4 mm), AAA (44.5×10.5 mm), AA (50×14 mm), C (49.2×25.5 mm) or D (60.5×33.2 mm) size. Cell 10 may also be a “⅔ A” cell (33.5×16.2 mm) or a CR2 cell (26.6×15.3 mm).

While a cell construction having a single anode tab and single cathode tab have been discussed above, multiple anode tabs and/or multiple cathode tabs can be used in some implementations, for example when a high current drain is desired.

Accordingly, other embodiments are within the scope of the following claims.

What is claimed is:

1. A method of manufacturing a battery, the method comprising:
providing a battery housing including a housing body and a portion defining a positive battery terminal;
providing a cathode assembly, comprising a cathode and a cathode tab configured to allow the cathode to be connected to the positive battery terminal;
cleaning a region of the cathode tab and/or a region of the positive battery terminal to remove an oxide layer from at least one of these regions; and
welding together the region of the cathode tab and the region of the positive battery terminal within 5 minutes of the cleaning step.

2. The method of claim 1 wherein cleaning comprises contacting the regions with a laser beam.

3. The method of claim 1 wherein cleaning is performed in a manner so as to remove substantially all of the oxide layer from the regions.

4. The method of claim 1 wherein welding is performed within 1 minute after cleaning is completed.

5. The method of claim 4 wherein welding is performed within 30 seconds after cleaning is completed.

6. The method of claim 1 wherein welding comprises laser welding.

7. The method of claim 2 wherein the laser beam comprises an Nd-YAG laser.

8. The method of claim 1 wherein cleaning is performed to a depth of about 5 to about 15 μm.

9. The method of claim 1 wherein the cathode tab is less than 0.2 mm thick.

10. The method of claim 2 wherein the laser beam comprises an Nd-YAG laser.

11. The method of claim 1 wherein cleaning comprises a mechanical process.

12. The method of claim 11 wherein the mechanical process is selected from the group consisting of milling, turning, scratching, scraping, buffing, and sanding.

13. The method of claim 1 wherein cleaning comprises a chemical process.

14. The method of claim 13 wherein the chemical process comprises etching.

15. The method of claim 1 wherein welding is performed in a manner so that the depth of weld penetration is about 40% to about 60% of the thickness of the thicker of the regions being welded.

16. The method of claim 1 wherein cleaning is performed for about 0.1 second to about 1.0 second.

17. The method of claim 1 wherein both cleaning and welding are performed using a laser beam, with a relatively low power density beam being used for cleaning and a relatively higher power density beam being used for welding.
